(19) United States
(12) Patent Application Publication
(10) Pub. No.: US 2026/0239139 A1
(43) Pub. Date: Aug. 13, 2026

(54) CELL SELECTION METHOD AND COMMUNICATION APPARATUS

(71) Applicant: BEIJING UNISOC COMMUNICATIONS TECHNOLOGY CO.,LTD., Beijing (CN)

(72) Inventor: Yajuan LI, Beijing (CN)

(73) Assignee: BEIJING UNISOC COMMUNICATIONS TECHNOLOGY CO.,LTD., Beijing (CN)

(21) Appl. No.: 19/470,766

(22) PCT Filed: Apr. 3, 2024
(86) PCT No.: PCT/CN2024/085718

§ 371 Date: Sep. 29, 2025

(30) Foreign Application Priority Data
Apr. 7, 2023 (CN) 202310371554.1

(51) Int. Cl. H04W 36/08; H04W 36/00

(52) U.S. Cl. CPC H04W 36/08; H04W 36/0061

(57) ABSTRACT

The present application discloses a cell selection method and a communication device. The method can comprises: sending a first query request message, wherein the first query request message comprises identifier information of M candidate cells, the first query request message is used for requesting to query time service information of the M candidate cells, and M is an integer greater than or equal to 1; and receiving a first query response message, wherein the first query response message comprises time service information of N candidate cells, and N is an integer greater than or equal to 1 and less than or equal to M. According to the present application, it can be ensured that a target cell after network transformation can meet the tome service requirements of services, thereby reducing the influence of network transformation on the services, and improving the service stability.

The present application claims priority to CN patent application No. 202310371554.1, entitled “METHOD FOR CELL SELECTION AND COMMUNICATION APPARATUS”, and filed with the China National Intellectual Property Administration on Apr. 7, 2023, the entity of which are incorporated herein by reference.

### FIELD OF TECHNOLOGY

The present application relates to communication technology, and particularly to a method for cell selection and a communication apparatus.

### BACKGROUND

A terminal device, during its movement, may experience network handovers, and it is very important to ensure that the services on the terminal device are not affected after a network handover. When the network accessed by the terminal device is switched, a source base station may decide a target cell to switch to for the terminal device. The target cell after the handover and a source cell before the handover may be provided by a same base station or different base stations. The source base station may, for example, select the target cell based on factors such as a Reference Signal Received Power measured by the terminal device or load balancing. However, for services with requirements for time service on the terminal device, the target cell selected in such a way may not be able to meet the requirements for time service of the services, thereby causing a service failure.

### SUMMARY

Embodiments of the present application provide a method and a communication apparatus for cell selection, which may ensure that the requirements for time service of the services may be met by a target cell after a network switch, thereby reducing the impact of the network switch on services and improving service stability.

In a first aspect, the present application provides a method for cell selection. The method comprises: transmitting a first query request message, the first query request message comprising identification information of M candidate cells, the first query request message requesting a query for information on time service of the M candidate cells, M being an integer greater than or equal to 1; and receiving a first query response message, the first query response message comprising the information on time service of N candidate cells, N being an integer greater than or equal to 1 and less than or equal to M. As can be seen, by querying the information on time service of candidate cells to select a cell whose parameters of time service meet the requirements for time service, the method facilitates reducing the impact of a network switch on services and improving service stability.

In an implementation, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N. As can be seen, the information on time service may include a result of time service indicating whether the parameters of time service meet or do not meet the requirements for time service, which facilitates a quicker selection of a cell whose parameters of time service meet the requirements for time service, thereby improving the efficiency of the cell selection.

In an implementation, the above method further comprises: determining a target cell according to the information on time service of the N candidate cells, parameters of time service of the target cell meeting the requirements for time service. As can be seen, by selecting a target cell whose parameters of time service meet the requirements for time service according to the information on time service of the candidate cells, the method may ensure that the requirements for time service of the service are met by the target cell after the network switch, thereby ensuring the service quality.

In an implementation, before the transmitting the first query request message, the method further comprises: receiving a first message, the first message comprising the identification information of the M candidate cells. As can be seen, receiving the first message facilitates transmitting the first query request message according to the first message.

In an implementation, the method further comprises: transmitting a second message, the second message comprising identification information of the target cell. As can be seen, transmitting the second message facilitates a cell handover.

In an implementation, before the transmitting the first query request message, the method further comprises: receiving a second query request message, the second query request message comprising identification information of K candidate cells, the second query request message requesting a query for information on time service of the K candidate cells, K being an integer greater than or equal to 1. As can be seen, receiving the second query request message facilitates a more flexible query of the information on time service of candidate cells according to the second query request message.

In an implementation, after the receiving the first query response message, the method further comprises: transmitting a second query response message, the second query response message comprising the information on time service of H candidate cells, H being an integer greater than or equal to 1 and less than or equal to N. As can be seen, transmitting the second query response message facilitates a flexible feedback of the information on time service of candidate cells.

In an implementation, the second query request message further comprises identification information of a criterion for time service, the criterion for time service indicating requirements for time service. As can be seen, identification information of the criterion for time service facilitates the determination of targeted results of time service of the candidate cells.

In an implementation, the above method further comprises: determining the results of time service of the N candidate cells according to the parameters of time service of the N candidate cells and the requirements for time service.

In an implementation, the above method further comprises: receiving a third message, the third message comprising identification information of a target cell, parameters of time service of the target cell meeting the requirements for time service. As can be seen, receiving the third message facilitates a cell handover.

In an implementation, the third message further comprises group identification information of the target cell.

In a second aspect, the present application provides another method for cell selection. The method comprises: receiving a query request message, the query request message comprising identification information of M candidate cells, the query request message requesting a query for information on time service of the M candidate cells, M being an integer greater than or equal to 1; and transmitting a query response message, the query response message comprising the information on time service of N candidate cells, N being an integer greater than or equal to 1 and less than or equal to M. As can be seen, providing the information on time service of candidate cells to select a cell whose parameters of time service meet the requirements for time service facilitates reducing the impact of a network switch on service and improving service stability.

In an implementation, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N. As can be seen, the information on time service including results of time service indicating whether the parameters of time service meet or do not meet the requirements for time service facilitates a quicker selection of a cell whose parameters of time service meet the requirements for time service, thereby improving the efficiency of the cell selection.

In an implementation, the information on time service of the N candidate cells comprises parameters of time service of the N candidate cells. As can be seen, providing the parameters of time service of the candidate cells facilitates improving the flexibility of cell selection.

In an implementation, the parameters of time service comprise any one or more parameters of: quality of service, area of service, and time of service.

In a third aspect, the present application provides yet another method for cell selection. The method comprises: transmitting a first request message, the first request message comprising identification information of M candidate cells, the first request message requesting a query for information on time service of the M candidate cells, M being an integer greater than or equal to 1; and receiving a first response message, the first response message comprising the information on time service of N candidate cells, N being an integer greater than or equal to 1 and less than or equal to M. As can be seen, querying the information on time service of candidate cells to select a cell whose parameters of time service meet the requirements for time service facilitates reducing the impact of a network switch on service and improving service stability.

In an implementation, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N. As can be seen, the information on time service including results of time service indicating whether the parameters of time service meet or do not meet the requirements for time service facilitates a quicker selection of a cell whose parameters of time service meet the requirements for time service, thereby improving the efficiency of the cell selection.

In an implementation, the above method further comprises: determining a target cell according to the information on time service of the N candidate cells, parameters of time service of the target cell meeting the requirements for time service. As can be seen, selecting a target cell whose parameters of time service meet the requirements for time service according to the information on time service of the candidate cells facilitates that the requirements for time service of the service are met by the target cell after the network switch, thereby ensuring the service quality.

In an implementation, the first request message further comprises identification information of a criterion for time service, the criterion for time service indicating requirements for time service. As can be seen, providing the criterion for time service facilitates improving the flexibility of cell selection.

In an implementation, the above method further comprises: transmitting a handover request message, the handover request message comprising identification information corresponding to the target cell. As can be seen, the transmitting handover request message facilitates a cell handover.

In an implementation, the handover request message further comprises group identification information of the target cell.

In a fourth aspect, the present application provides a communication apparatus including a transmission unit and a receiving unit, wherein: the transmission unit is configured to transmit a first query request message, the first query request message comprising identification information of M candidate cells, the first query request message requesting a query for information on time service of the M candidate cells, M being an integer greater than or equal to 1; and the receiving unit is configured to receive a first query response message, the first query response message comprising the information on time service of N candidate cells, N being an integer greater than or equal to 1 and less than or equal to M.

In a fifth aspect, the present application provides another communication apparatus including a transmission unit and a receiving unit, wherein: the receiving unit is configured to receive a query request message, the query request message comprising identification information of M candidate cells, the query request message requesting a query for information on time service of the M candidate cells, M being an integer greater than or equal to 1; and the transmission unit is configured to transmit a query response message, the query response message comprising the information on time service of N candidate cells, N being an integer greater than or equal to 1 and less than or equal to M.

In a sixth aspect, the present application provides yet another communication apparatus including a transmission unit and a receiving unit, wherein: the transmission unit is configured to transmit a first request message, the first request message comprising identification information of M candidate cells, the first request message requesting a query for information on time service of the M candidate cells, M being an integer greater than or equal to 1; and the receiving unit is configured to receive a first response message, the first response message comprising the information on time service of N candidate cells, N being an integer greater than or equal to 1 and less than or equal to M.

In a seventh aspect, the present application provides a communication apparatus including a processor, a memory, and computer programs or instructions stored on the memory, wherein the processor executes the computer programs or instructions to implement the method according to the first aspect and any implementation thereof, or to implement the method according to the second aspect and any implementation thereof, or to implement the method according to the third aspect and any implementation thereof.

In an eighth aspect, the present application provides a chip. In an implementation, the chip is configured to: transmit a first query request message, the first query request message comprising identification information of M candidate cells, the first query request message requesting a query for information on time service of the M candidate cells, M being an integer greater than or equal to 1; and receive a first query response message, the first query response message comprising the information on time service of N candidate cells, N being an integer greater than or equal to 1 and less than or equal to M. In another implementation, the chip is configured to: receive a query request message, the query request message comprising identification information of M candidate cells, the query request message requesting a query for information on time service of the M candidate cells, M being an integer greater than or equal to 1; and transmit a query response message, the query response message comprising the information on time service of N candidate cells, N being an integer greater than or equal to 1 and less than or equal to M. In yet another implementation, the chip is configured to: transmit a first request message, the first request message comprising identification information of M candidate cells, the first request message requesting a query for information on time service of the M candidate cells, M being an integer greater than or equal to 1; and receive a first response message, the first response message comprising the information on time service of N candidate cells, N being an integer greater than or equal to 1 and less than or equal to M.

In a ninth aspect, the present application provides a computer-readable storage medium having computer-readable instructions stored therein, the computer-readable instructions when being executed, implementing the method according to the first aspect and any implementation thereof, or the method according to the second aspect and any implementation thereof, or the method according to the third aspect and any implementation thereof.

In a tenth aspect, the present application provides a computer program or computer program product, including codes or instructions, the codes or instructions, when being executed on a computer, causing the computer to perform the method according to the first aspect and any implementation thereof, or to perform the method according to the second aspect and any implementation thereof, or to perform the method according to the third aspect and any implementation thereof.

In an eleventh aspect, the present application provides a chip module, the chip module includes a communication module, a power module, a storage module, and a chip, wherein: the power module is configured to provide power for the chip module; the storage module is configured to store data and instructions; the communication module is configured for internal communication within the chip module, or for communication between the chip module and external devices; and the chip is configured to perform the method according to the first aspect and any implementation thereof, or perform the method according to the second aspect and any implementation thereof, or perform the method according to the third aspect and any implementation thereof.

### BRIEF DESCRIPTION OF THE DRAWINGS

FIG. 1 is a schematic diagram of a system architecture applied to an embodiment of the present application;

FIG. 2 is a schematic flowchart of an Xn based handover procedure provided by an embodiment of the present application;

FIG. 3 is a schematic flowchart of a preparation phase of an N2 based handover procedure provided by an embodiment of the present application;

FIG. 4 is a schematic flowchart of an execution phase of an N2 based handover procedure provided by an embodiment of the present application;

FIG. 5 is a schematic flowchart of a method for cell selection provided by an embodiment of the present application;

FIG. 6 is schematic flowchart of another method for cell selection provided by an embodiment of the present application;

FIG. 7 is schematic flowchart of yet another method for cell selection provided by an embodiment of the present application;

FIG. 8 is a schematic structural diagram of a communication apparatus provided by an embodiment of the present application;

FIG. 9 is a schematic structural diagram of another communication apparatus provided by an embodiment of the present application; and

FIG. 10 is a schematic structure diagram of a chip module provided by an embodiment of the present application.

### DETAILED DESCRIPTION OF EMBODIMENTS

In the present application, terms such as “first” and “second” are used to distinguish between identical items or similar items that have substantially the same functionality and effect. Those skilled in the art will understand that terms such as “first” and “second” do not pose limitation on the quantity and order of execution, and also do not limit that they are different. The term “and/or” describes a relationship between related objects, indicating that three types of relationships may exist. For example, A and/or B may indicate: A alone, both A and B, or B alone. The character “/” indicates an “or” relation between the two objects before and after the character.

It should be understood that in the present application, “at least one” refers to one or more, and “a plurality of” refers to two or more. Furthermore, the term “equal to” in the present application may be used together with the terms “greater than” or “less than”. When “equal to” is used together with “greater than”, the technical solution of “greater than” is adopted; when “equal to” is used together with “less than”, the technical solution of “less than” is adopted.

Firstly, the system architecture related to the present application is illustrated.

Embodiments of the present application may be applied to an NR system, also referred to as a fifth-generation (5G) system; or may also be applied to a sixth-generation (6G) system, a seventh-generation (7G) system, or other future communication systems.

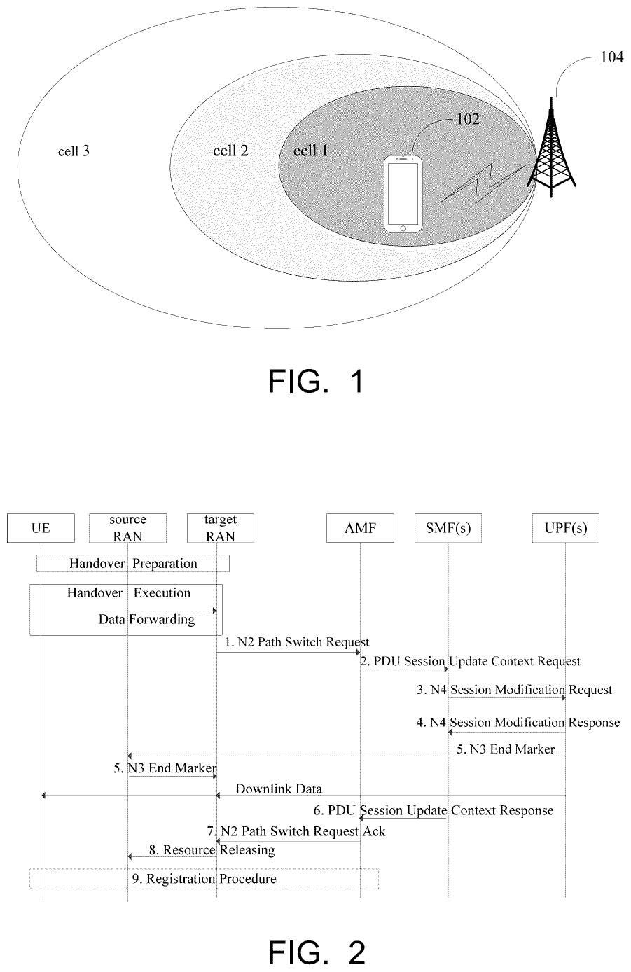

The present application may be applied to a system architecture shown in FIG. 1. The communication system shown in FIG. 1 may include a terminal device 102 and a network device 104. It should be noted that the number and form of devices shown in FIG. 1 are for exemplary illustration only and do not constitute limitations to the embodiments of the present application. In practical applications, there may be a number of terminal devices and a number of network devices different from those shown in FIG. 1.

The terminal device 102 is a device with functionality of wireless transceiver, which may be referred to as a terminal, a User Equipment (UE), a Mobile Station (MS), a Mobile Terminal (MT), an access terminal device, an Internet of Things terminal device, a vehicle-mounted terminal device, an industrial control terminal device, a UE unit, a UE station, a mobile station, a remote station, a remote terminal device, a mobile device, a UE terminal device, a wireless communication device, a UE agent, or a UE apparatus, etc. The terminal device may be stationary or mobile. It should be noted that the terminal device may support at least one wireless communication technology, such as Long Term Evolution (LTE), New Radio (NR), Wideband Code Division Multiple Access (WCDMA), etc. For example, the terminal device may be a mobile phone, a pad, a desktop computer, a laptop, an all-in-one computer, a vehicle-mounted terminal, a Virtual Reality (VR) terminal device, an Augmented Reality (AR) terminal device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a Session Initiation Protocol (SIP) phone, a Wireless Local Loop (WLL) station, a Personal Digital Assistant (PDA), a handheld device with functionality of wireless communication, a computing device, or another processing device connected to a wireless modem, a wearable device, a terminal device in a future mobile communication network, or a terminal device in a future evolved Public Land Mobile Network (PLMN), etc. In some embodiments of the present application, the terminal device may also be an apparatus with functionality of transceiver, such as a chip module. The chip module may include a chip and may also include other discrete devices. The embodiments of the present application do not pose limitation on the specific technology and form of device adopted by the terminal device.

The network device 104 may be a device that provides functionality of wireless communication for terminal devices. The network device may be an Access Network (AN) device, and a satellite. The AN device may be a Radio Access Network (RAN) device. The access network device may support at least one wireless communication technology, such as LTE, NR, WCDMA, etc. For example, the access network device includes but is not limited to: a next-generation Node B (gNB) in a fifth-generation mobile communication system (5G), an evolved Node B (eNB), a Radio Network Controller (RNC), a Node B (NB), a Base Station Controller (BSC), a Base Transceiver Station (BTS), a home base station (e.g., a Home evolved Node B, or a Home Node B, HNB), a Baseband Unit (BBU), a Transmission and Reception Point (TRP), a Transmission Point (TP), a Mobile Switching Center, etc. The network device may also be a wireless controller, a Centralized Unit (CU), and/or a Distributed Unit (DU) in a Cloud Radio Access Network (CRAN) scenario, or the access network device may be a relay station, an access point, a vehicle-mounted device, a wearable device, an access network device in future mobile communications, or an access network device in a future evolved PLMN, etc. In some embodiments, the network device may also be an apparatus with the functionality of providing wireless communication for terminals device, such as a chip module. For example, the chip module may include a chip and may also include other discrete devices. The embodiments of the present application do not pose limitation on the specific technology and form of device adopted by the network device.

It should be understood that the communication system described in the embodiments of the present application is to illustrate the technical solutions of the embodiments of the present application more clearly and does not constitute a limitation on the technical solutions provided by the embodiments of the present application. Those skilled in the art will know that as the system architecture evolves and new service scenarios emerge, the technical solutions provided by the embodiments of the present application are equally applicable to similar technical problems.

Secondly, concepts related to the present application are illustrated.

### 1. Air Interface Time Transfer

With the continuous development of 5G, base stations may provide time transfer in high-precision over the Uu interface for UEs by broadcasting System Information Blocks (SIBs), such as SIB9, or via Radio Resource Control (RRC) dedicated signaling, such as a Downlink (DL) Information Transfer (DLInformationTransfer) message.

For example, an SIB9 message may contain the following fields:
timeInfoUTC—indicating Universal Coordinated Time (UTC) related information, corresponding to a System Frame Number (SFN) at or after an end boundary of a SI window in which SIB9 is transmitted;
dayLightSavingTime—indicating whether and how to apply daylight saving time to acquire local time;
leapSeconds—indicating a number of leap seconds for an offset between GPS time and UTC; and
localTimeOffset—indicating an offset between UTC and local time, in 15-minute.

### 2. Network Handover

The network handover related to the embodiments of the present application may be classified as an Xn based handover and an N2 based handover from the perspective of a handover procedure. Xn is an interface between an access network device and another access network device, and N2 is an interface between an access network device and an Access and Mobility Management Function AMF Network Element.

### (1) Xn Based Handover

Referring to FIG. 2, FIG. 2 is a schematic flowchart of an Xn based handover procedure provided by an embodiment of the present application. As shown in FIG. 2, the Xn based handover procedure may be divided into a preparation phase of handover procedure and an execution phase of handover procedure. The preparation phase of handover procedure mainly includes: transmitting a handover request message from a source RAN to a target RAN; confirming, by the target RAN, whether it may support an establishment of bearers according to the specific situation and replying to the source RAN, etc. The execution phase of handover procedure mainly includes: transmitting a handover request message from the source RAN to the UE; executing handover, by the UE, to the target RAN according to the handover request message; and transmitting, after the handover is completed and from the target RAN to the core network element, a notification message of switching the path for data transmission, etc.

### (2) N2 Based Handover

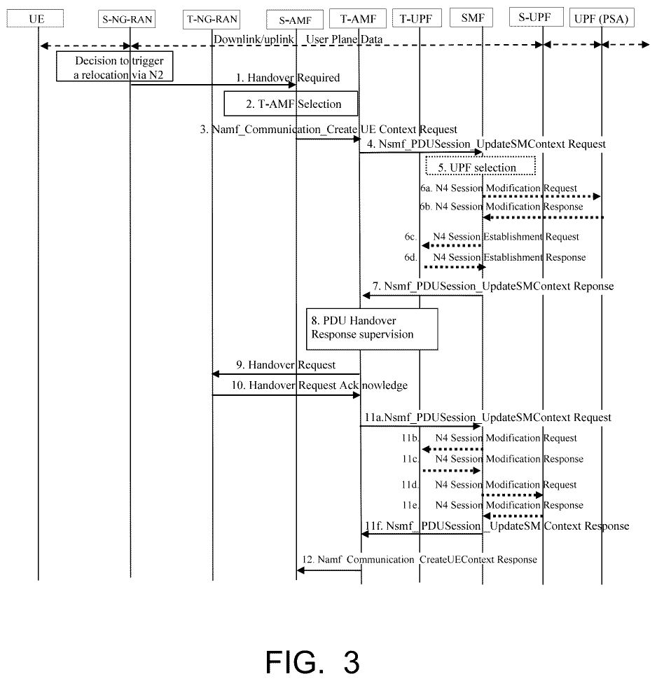

An N2 based handover procedure may also be divided into a preparation phase of handover procedure and an execution phase of handover procedure. Referring to FIG. 3, FIG. 3 is a schematic flowchart of a preparation phase of an N2 based handover procedure provided by an embodiment of the present application. As shown in FIG. 3, a source RAN initiates a handover request message; a core network element interacts with a target RAN to confirm a bearer that can be switched to; a Session Management Function (SMF) network element/an AMF network element will establish a Protocol Data Unit (PDU) session on the target side; and after the establishment, the SMF network element will reply to the AMF network element.

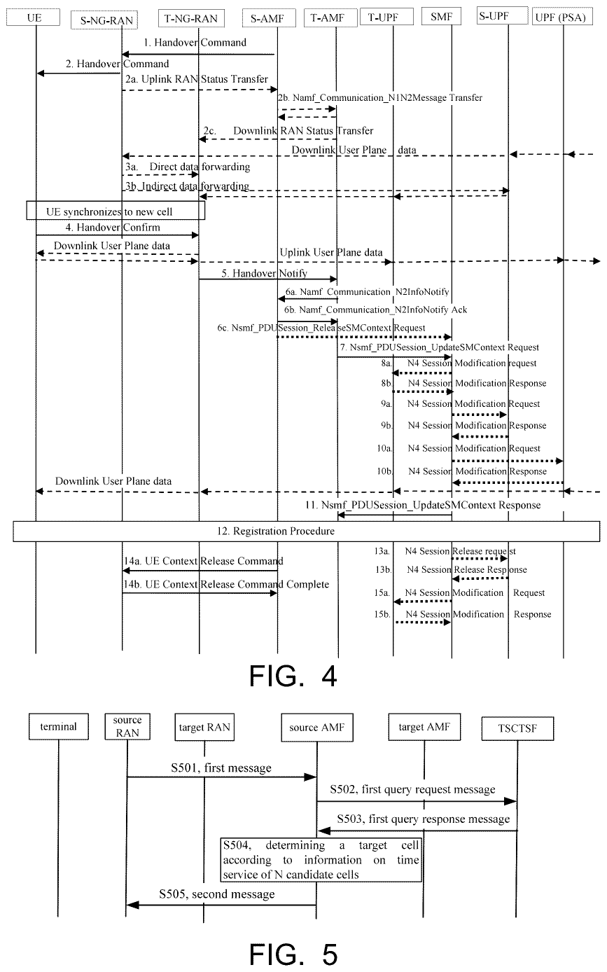

Further, referring to FIG. 4, FIG. 4 is a schematic flowchart of an execution phase of an N2 based handover procedure provided by an embodiment of the present application. As shown in FIG. 4, an AMF network element transmits a handover command message to a source RAN, informing the source RAN that the preparation phase of handover procedure has been completed. The source RAN may transmit a handover command to a UE, triggering the UE to execute a handover to the target RAN. After the handover is completed, the UE transmits a handover confirmation message to the target RAN. Subsequent steps in the procedure relate to interacting with, by the target RAN, a core network element to update a session on the target side, and switching the path for data transmission, etc.

### 3. Parameters for Time Service

The contents of parameters for time service include the following as shown in Table 1 below.

TABLE 1

| Information Name | Description | Category |
|---|---|---|
| Synchronization | Indicates the state of the node | Optional |
| state | synchronization, represented by | |
| | the-values “Locked”, | |
| | “Holdover”, | |
| | or “Freerun”(NOTE. 1). | |
| Synchronization | Traceable-to-UTC | Optional |
| performance | Traceable-to-GNSS | |
| | Frequency-stability | |
| Clock quality | clock-accuracy | Optional |
| Time source | Describes the primary source the | Optional |
| | node is currently using. | |
| | Represented by the values | |
| | “SyncE”, “PTP”, “GNSS”, | |
| | “atomic clock”, “terrestrial radio”, | |
| | “serial. time code”, “NTP”, “hand | |
| | set”, and “other” | |

Next, the methods for cell selection provided by the embodiments of the present application are illustrated.

Referring to FIG. 5, FIG. 5 is a schematic flowchart of a method for cell selection provided by an embodiment of the present application. The method may include but is not limited to the following steps:

S501, transmitting a first message from a source RAN to a source AMF network element. Correspondingly, the source AMF network element may receive the first message from the source RAN.

Here, the source RAN may be considered as a RAN to which the UE is connected before a cell handover, and the source AMF network element may be considered as an AMF network element serving the UE before the cell handover. The first message may be a handover request message. The first message may include identification information of M candidate cells, where M is an integer greater than or equal to 1.

S502, transmitting a first query request message from the source AMF network element to a Time Sensitive Communication and Time Synchronization Function (TSCTSF). Correspondingly, the TSCTSF network element may receive the query request message from the source AMF network element.

The first query request message may include identification information of the M candidate cells. The first query request message may request a query for information on time service of the M candidate cells. Alternatively, the first query request message may also include identification information of a candidate AMF network element.

S503, transmitting a first query response message from the TSCTSF network element to the source AMF network element. Correspondingly, the source AMF network element may receive the first query response message from the TSCTSF network element.

The TSCTSF network element may determine the information on time service of the M candidate cells according to the identification information of the M candidate cells.

The first query response message transmitted from the TSCTSF network element to the source AMF network element may include information on time service of N candidate cells, where N is an integer greater than or equal to 1 and less than or equal to M. When N is an integer less than M, this represents that the TSCTSF network element may select from the M candidate cells and may transmit the information on time service of the selected N candidate cells to the source AMF network element. For example, the N candidate cells may be candidate cells that are selected by the TSCTSF network element, whose parameters for time service meet the requirements for time service, from the M candidate cells.

Alternatively, the first query response message may also include Tracking Area (TA) information and/or candidate cell information. The candidate cell information may include, for example, a Cell Global Identifier (CGI), or a Physical Cell Identifier (PCI), or resource configuration information of a candidate cell.

S504, determining, by the source AMF network element, a target cell according to the information on time service of the N candidate cells.

The parameters for time service of the target cell meet the requirements for time service.

In an implementation, the information on time service of the N candidate cells may include results of time service of the N candidate cells, i.e., the first query response message received by the source RAN from the source AMF network element may include the results of time service of the N candidate cells. A result of time service of an n-th candidate cell may indicate whether or not parameters for time service of the n-th candidate cell meet the requirements for time service, where n is an integer greater than or equal to 1 and less than or equal to N. The source AMF network element may determine a target cell, whose parameters for time service meet the requirements for time service, according to the results of time service of the N candidate cells. Alternatively, if the source AMF network element fails to receive the first query response message from the TSCTSF network element within a preset period of time, it may be determined by default that the parameters for time service of the n-th candidate cell meet the requirements for time service.

In another implementation, information on time service of the N candidate cells may include parameters of time service of the N candidate cells, i.e., the query response message received by the source RAN from the source AMF network element may include the parameters of time service of the N candidate cells. The source AMF network element may determine a target cell, whose parameters for time service meet the requirements for time service, according to the parameters of time service of the N candidate cells and the requirements for time service. Alternatively, the parameters of time service may comprise any one or more parameters of: quality of service, area of service, and time of service.

If the source AMF network element determines that there are a plurality of target cells whose parameters of time service meet the requirements for time service, the source AMF network element may select a target for handover according to the quality of signal of the plurality of target cells, for example, it may select a target cell with the highest quality of signal as the target for handover. Alternatively, the source AMF network element may also select a target cell with the maximum number of residences as the target for handover according to statistical information of the plurality of target cells.

Further, the source AMF network element may select a target AMF network element for handover.

In an implementation, if the first query request message transmitted from the source AMF network element to the TSCTSF network element includes the identification information of the M candidate cells, after receiving the first query request message from the source AMF network element, the TSCTSF network element may determine the results of time service of the M candidate cells and the AMF network elements corresponding to the M candidate cells. The TSCTSF network element may transmit the results of time service of the N candidate cells and the AMF network elements corresponding to the N candidate cells to the source AMF network element. The results of time service of the N candidate cells and the AMF network elements corresponding to the N candidate cells may be configured at the source AMF network element, for example, in a form of a table. In this way, after determining a target cell, the source AMF network element may determine the target AMF network element corresponding to the target cell for handover according to the target cell.

In another implementation, if the first query request message transmitted from the source AMF network element to the TSCTSF network element includes the identification information of a candidate AMF network element, after receiving the first query request message from the source AMF network element, the TSCTSF network element may determine the result of time service of the candidate cell corresponding to the candidate AMF network element. The TSCTSF network element may in turn transmit the result of time service of the candidate cell corresponding to the candidate AMF network element to the source AMF network element. The source AMF network element may determine a target cell and a target AMF network element corresponding to the target cell according to the result of time service of the candidate cell corresponding to the candidate AMF network element. For example, assuming that the first query request message transmitted from the source AMF network element to the TSCTSF network element includes the identification information of two candidate AMF network elements, i.e., AMF1 and AMF2. The TSCTSF network element may determine the result of time service of a candidate cell corresponding to AMF1 and the result of time service of a candidate cell corresponding to AMF2. If the result of time service of the candidate cell corresponding to AMF1 indicates that the parameters of time service of the candidate cell corresponding to AMF1 meet the requirements for time service, and the result of time service of the candidate cell corresponding to AMF2 indicates that the parameters of time service of the candidate cell corresponding to AMF2 do not meet the requirements for time service, after receiving the result of time service of the candidate cell corresponding to AMF1 and the result of time service of the candidate cell corresponding to AMF2, the source AMF network element may determine that the target cell is the candidate cell corresponding to AMF1, and the target AMF network element is AMF1. S505, transmitting a second message from the source AMF network element to the source RAN. Correspondingly, the source RAN may receive the second message from the source AMF network element.

The second message may comprise identification information of the target cell. The second message may be a handover response message. Alternatively, when none of the parameters of time service of the N candidate cells meets the requirements for time service, the second message may indicate a rejection for handover and carry a reason for rejection. In this case, the second message may be a handover preparation failure message.

In the embodiment shown in FIG. 5, the source AMF network element may determine a target cell, whose parameters of time service meet the requirements for time service, according to the information on time service of the N candidate cells, ensuring that the requirements for time service of services may be met by the target cell after the network handover, thereby reducing the impact of the network switch on services and improving service stability.

Referring to FIG. 6, FIG. 6 is a schematic flowchart of another method for cell selection provided by an embodiment of the present application. The method may include but is not limited to the following steps:

S601, transmitting a first query request message from a source RAN to a source AMF network element. Correspondingly, the source AMF network element receives the first query request message from the source RAN.

The source RAN may be considered as a RAN to which the UE is connected before a cell handover, and the source AMF network element may be considered as an AMF network element serving the UE before the cell handover. The first query request message may include identification information of M candidate cells, where M is an integer greater than or equal to 1. Alternatively, the M candidate cells may be potential target cells for handover determined by the source RAN. The M candidate cells may be provided by a same RAN, by different RANs, or some of the M candidate cells may be provided by the same RAN and some of the M candidate cells may be provided by different RANs. The embodiment of the present application does not pose limitation on it. It should be understood that the M candidate cells may also be provided by an RAN which is same as or different from the RAN providing the source cell before the cell handover of the UE.

Alternatively, the first query request message may also include identification information of a criterion for time service. The criterion for time service may indicate the requirements for time service of the current service. The identification information of the criterion for time service may be, for example, an index value of the criterion for time service. Alternatively, the first query request message may also include the details of the criterion for time service. For example, assuming that finance type service A is being executed on the UE currently, and the requirement for time service of the finance type service A is a deviation of 1 ms. The first query request message may include the details of the criterion for time service for service A, i.e., a deviation of 1 ms.

S602, transmitting a second query request message from the source AMF network element to the TSCTSF network element. Correspondingly, the TSCTSF network element receives the second query request message from the source AMF network element.

In the embodiment of the present application, in case of receiving the first query request message from the source RAN, the source AMF network element may transmit a second query request message to the TSCTSF network element. The second query request message may include the identification information of the M candidate cells. The second query request message request a query for the information on time service of the M candidate cells. The TSCTSF network element may query and acquire the information on time service of the M candidate cells according to the identification information of the M candidate cells.

Alternatively, the second query request message transmitted from the source AMF network element to the TSCTSF network element may also include identification information of a candidate AMF network element.

S603, transmitting a second query response message from the TSCTSF network element to the source AMF network element. Correspondingly, the source AMF network element receives the second query response message from the TSCTSF network element.

The TSCTSF network element may transmit a second query response message to the source AMF network element. The second query response message may include information on time service of K candidate cells, where K is an integer greater than or equal to 1 and less than or equal to M. When K is an integer less than M, this represents that the TSCTSF network element may select from the M candidate cells and may transmit the information on time service of the selected K candidate cells to the source AMF network element. For example, the K candidate cells may be candidate cells selected by the TSCTSF network element, whose information on time service meet the requirements for time service, from the M candidate cells.

Alternatively, the second query response message may also include Tracking Area (TA) information and/or candidate cell information. The candidate cell information may include, for example, a Cell Global Identifier (CGI), or a Physical Cell Identifier (PCI), or resource configuration information of a candidate cell.

S604, transmitting a first query response message from the source AMF network element to the source RAN. Correspondingly, the source RAN receives the first query response message from the source AMF network element.

In case of receiving the second query response message from the TSCTSF network element, the source AMF network element may transmit a first query response message to the source RAN. The first query response message may include information on time service of N candidate cells, where N is an integer greater than or equal to 1 and less than or equal to K. When N is an integer less than K, this represents that the source AMF network element may select from the K candidate cells and may transmit the information on time service of the selected N candidate cells to the source RAN. For example, the N candidate cells may be candidate cells selected by the source AMF network element, whose information on time service meet the requirements for time service, from the K candidate cells.

S605, determining, by the source RAN, a target cell according to the information on time service of the N candidate cells.

The parameters of time service of the target cell meet the requirements for time service of the current service.

In an implementation, the information on time service of the N candidate cells may include results of time service of the N candidate cells, i.e., the first query response message received by the source RAN from the source AMF network element may include results of time service of the N candidate cells. A result of time service of an n-th candidate cell may indicate that the parameters of time service of the n-th candidate cell meet the requirements for time service or that the parameters of time service of the n-th candidate cell do not meet the requirements for time service of the current service, where n is an integer greater than or equal to 1 and less than or equal to N. The source RAN may determine a target cell, whose parameters of time service meet the requirements for time service of the current service, according to the results of time service of the N candidate cells. Alternatively, if the source RAN fails to receive the first query response message from the source AMF network element within a preset period of time, it may be determined by default that the parameters of time service of the n-th candidate cell meet the requirements for time service of the current service.

Alternatively, the results of time service of the N candidate cells may be determined by the source AMF network element according to the requirements for time service of the current service and the parameters of time service of the N candidate cells provided by the TSCTSF network element. Alternatively, the results of time service of the N candidate cells may also be determined by the TSCTSF network element according to the requirements for time service of the current service and the parameters of time service of the N candidate cells.

In another implementation, the information on time service of the N candidate cells may include parameters of time service of the N candidate cells, i.e., the first query response message received by the source RAN from the source AMF network element may include parameters of time service of the N candidate cells. The source RAN may determine a target cell whose parameters of time service meet the requirements for time service of the current service according to the parameters of time service of the N candidate cells and the requirements for time service of the current service. Alternatively, the parameters of time service may comprise any one or more parameters of: quality of service, area of service, and time of service.

Alternatively, after determining the target cell, the source RAN may transmit a handover request message to the source AMF network element. The handover request message may include identification information of the target cell, and the parameters of time service of the target cell meet the requirements for time service of the current service.

Alternatively, the target cell may be a group of cells. The handover request message may also include group identification information of the target cell.

In the embodiment shown in FIG. 6, the source RAN may determine a target cell, whose parameters of time service meet the requirements for time service of the current service, according to the information on time service of the N candidate cells, ensuring that the requirements for time service of the service may be met by the target cell after the network switch, thereby reducing the impact of the network switch on service and improving service stability.

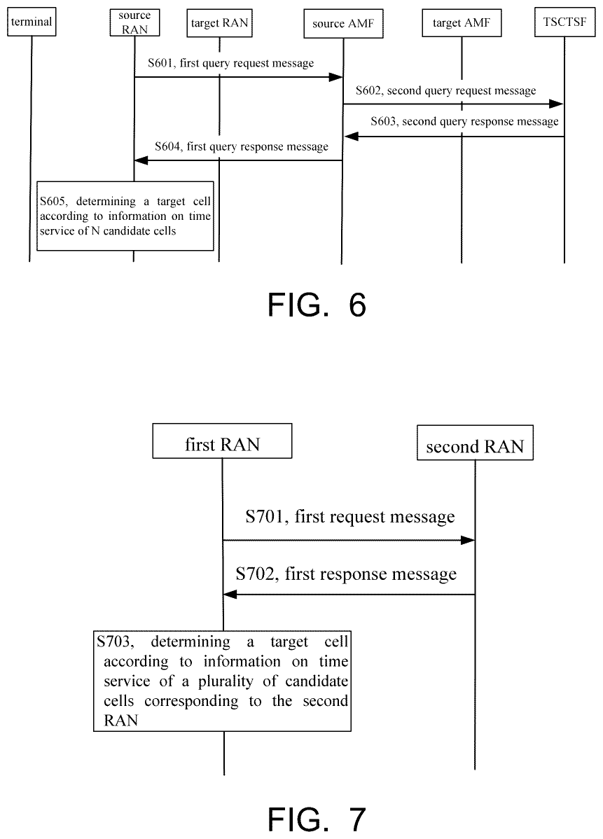

Referring to FIG. 7, FIG. 7 is a schematic flowchart of yet another method for cell selection provided by an embodiment of the present application. The method may include but is not limited to the following steps:

S701, transmitting a first request message from a first RAN to a second RAN. Correspondingly, the second RAN receives the first request message from the first RAN.

The first RAN may be a source RAN, i.e., a RAN to which the UE is connected before a cell handover. The first request message may include identification information of a plurality of cells corresponding to the second RAN. The first request message requests to acquire information on time service of the plurality of cells corresponding to the second RAN. Alternatively, the first request message may include requirements for time service. The second RAN may determine the information on time service of the plurality of cells corresponding to the second RAN according to the identification information of the plurality of cells corresponding to the second RAN and the requirements for time service.

Alternatively, the first request message may include a subscription message for time service. When the first request message is the subscription message for time service, the first RAN may be subscribed to the information on time service of the plurality of cells corresponding to the second RAN. That is, when there is a change in the information on time service of the plurality of cells corresponding to the second RAN, the first RAN may receive a notification message for time service.

S702, transmitting a first response message from the second RAN to the first RAN. Correspondingly, the first RAN receives the first response message from the second RAN.

The first response message may include information on time service of the plurality of cells corresponding to the second RAN.

Alternatively, the information on time service of the plurality of cells corresponding to the second RAN may include results of time service of the plurality of cells corresponding to the second RAN. The result of time service of a first cell of the plurality of cells indicates whether or not parameters of time service of the first cell meet the requirements for time service, where the first cell may be any one of the plurality of cells corresponding to the second RAN. Alternatively, if the first RAN failed to receive the first response message within a preset time, it may be determined by default that the parameters of time service of the first cell meet the requirements for time service.

Alternatively, the information on time service of the plurality of cells corresponding to the second RAN may include parameters of time service of the plurality of cells corresponding to the second RAN. The parameters of time service may comprise any one or more parameters of: quality of service, area of service, and time of service.

Alternatively, the first response message may be a notification message for time service. If the first RAN receives the notification message for time service, this represents that there is a change in the information on time service of the plurality of cells corresponding to the second RAN.

S703, determining, by the first RAN, a target cell according to the information on time service of the plurality of cells corresponding to the second RAN.

The parameters of time service of the target cell meet the requirements for time service.

In an implementation, the information on time service of the plurality of cells corresponding to the second RAN may include results of time service of the plurality of cells corresponding to the second RAN. The first RAN may determine a target cell whose parameters of time service meet the requirements for time service according to the results of time service of the plurality of cells corresponding to the second RAN.

In another implementation, the information on time service of the plurality of cells corresponding to the second RAN may include parameters of time service of the plurality of cells corresponding to the second RAN. The first RAN may determine a target cell whose parameters of time service meet the requirements for time service according to the parameters of time service of the plurality of cells corresponding to the second RAN and the requirements for time service.

Further, after determining the target cell, the first RAN may execute the cell handover. It should be understood that if none of the parameters of time service of the plurality of cells corresponding to the second RAN meets the requirements for time service, the first RAN may not execute the cell handover.

In the embodiment shown in FIG. 7, the first RAN may determine a target cell whose parameters of time service meet the requirements for time service according to the information on time service of the plurality of cells corresponding to the second RAN, ensuring that the requirements for time service of the service may be met by the target cell after the network switch, thereby reducing the impact of the network switch on service and improving service stability.

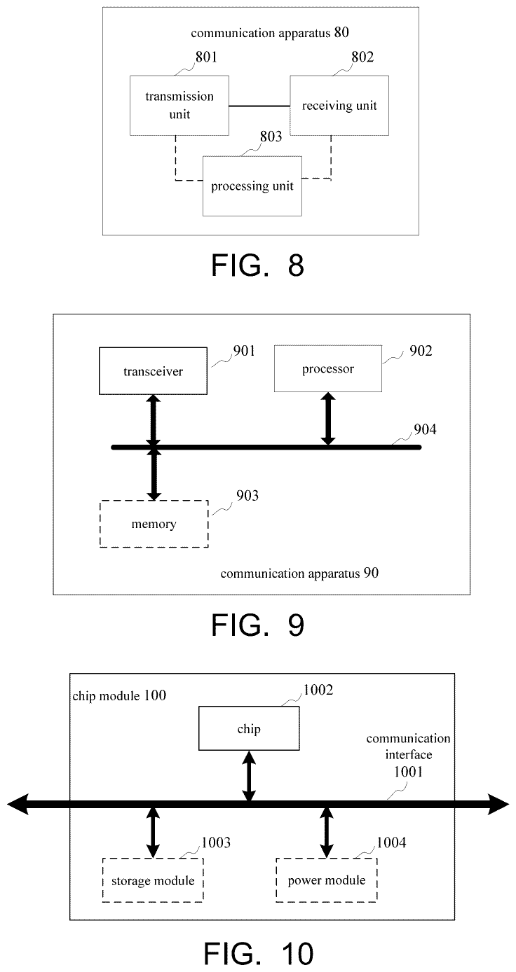

Referring to FIG. 8, FIG. 8 is a schematic structure diagram of a communication apparatus provided by an embodiment of the present application. As shown in FIG. 8, the communication apparatus 80 includes a transmission unit 801 and a receiving unit 802.

In an implementation, the communication apparatus 80 is an AMF network element or an apparatus equivalent to the AMF network element.

The transmission unit 801 is configured to transmit a first query request message, the first query request message comprising identification information of M candidate cells, the first query request message requesting a query for information on time service of the M candidate cells, M being an integer greater than or equal to 1.

The receiving unit 802 is configured to receive a first query response message, the first query response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the communication apparatus 80 may further include a processing unit 803. The processing unit 803 is configured to determine a target cell according to the information on time service of the N candidate cells, the parameters of time service of the target cell meeting the requirements for time service.

Alternatively, the receiving unit 802 is further configured to receive a first message, the first message comprising the identification information of the M candidate cells.

Alternatively, the transmission unit 801 is configured to transmit a second message, the second message comprising identification information of the target cell.

Alternatively, the receiving unit 802 is further configured to receive a second query request message, the second query request message comprising identification information of K candidate cells, the second query request message requesting a query for information on time service of the K candidate cells, K being an integer greater than or equal to 1.

Alternatively, the transmission unit 801 is further configured to transmit a second query response message, the second query response message comprising the information on time service of H candidate cells, H being an integer greater than or equal to 1 and less than or equal to N.

Alternatively, the second query request message further comprises identification information of a criterion for time service, the criterion for time service indicating requirements for time service.

Alternatively, the processor unit 803 is further configured to determine the results of time service of the N candidate cells according to the parameters of time service of the N candidate cells and the requirements for time service.

Alternatively, the receiving unit 802 is further configured to receive a third message, the third message comprising identification information of the target cell, the parameters of time service of the target cell meeting the requirements for time service.

Alternatively, the third message further comprises group identification information of the target cell.

In another implementation, the communication apparatus 80 is a TSCTSF network element or an apparatus equivalent to the TSCTSF network element.

The receiving unit 802 is configured to receive a query request message, the query request message comprising identification information of M candidate cells, the query request message requesting a query for information on time service of the M candidate cells, M being an integer greater than or equal to 1.

The transmission unit 801 is configured to transmit a query response message, the query response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the information on time service of the N candidate cells comprises parameters of time service of the N candidate cells.

Alternatively, the parameters of time service comprise any one or more parameters of: quality of service, area of service, and time of service.

In another implementation, the communication apparatus 80 is an RAN or an apparatus equivalent to the RAN.

The transmission unit 801 is configured to transmit a first request message, the first request message comprising identification information of M candidate cells, the first request message requesting a query for information on time service of the M candidate cells, M being an integer greater than or equal to 1.

The receiving unit 802 is configured to receive a first response message, the first response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the processor unit 803 is configured to determine a target cell according to the information on time service of the N candidate cells, parameters of time service of the target cell meeting the requirements for time service.

Alternatively, the first request message further comprises identification information of a criterion for time service, the criterion for time service indicating requirements for time service.

Alternatively, the transmission unit 801 is further configured to transmit a handover request message, the handover request message comprising identification information corresponding to the target cell.

Alternatively, the handover request message further comprises group identification information of the target cell.

Referring to FIG. 9, FIG. 9 is another communication apparatus provided by an embodiment of the present application. The communication apparatus 90 may include a transceiver 901 and a processor 902. Alternatively, the communication apparatus may further include a memory 903. The transceiver 901, the processor 902, and the memory 903 may be connected via a bus 904 or connected in other forms. The bus is represented in a bold line in FIG. 9. The forms of connection between other components are only for schematic illustration and are not for limitation. The bus may be classified as an address bus, a data bus, a control bus, etc. For ease of illustration, only one bold line is shown in FIG. 9, but it does not mean that there is only one bus or one type of bus.

“Coupling” in the embodiments of the present application is indirect coupling or communication connection between devices, units, or modules, which may be electrical, mechanical, or other forms, and are used for information interaction between devices, units, or modules. In the embodiments of the present application, the medium for connection between the transceiver 901, the processor 902, and the memory 903 is not specifically limited herein.

The memory 903 may include read-only memory and random access memory, and provides instructions and data to the processor 902. A part of the memory 903 may also include non-volatile random access memory.

The processor 902 may be a Central Processing Unit (CPU), or the processor 902 may be another general-purpose processor, a Digital Signal Processor (DSP), an Application Specific Integrated Circuit (ASIC), a Field-Programmable Gate Array (FPGA), or another programmable logic device, discrete gate or transistor logic device, discrete hardware component, etc. The general-purpose processor may be a microprocessor, or alternatively, the processor 902 may be any conventional processor, etc.

In an optional embodiment, the memory 903 is configured to store program instructions; and the processor 902 is configured to invoke the program instructions stored in the memory 903 to perform the steps executed by the source AMF network element in the embodiments corresponding to FIGS. 5-7.

In another optional embodiment, the memory 903 is configured to store program instructions; and the processor 902 is configured to invoke the program instructions stored in the memory 903 to perform the steps executed by the TSCTSF network element in the embodiments corresponding to FIGS. 5-7.

In yet another optional embodiment, the memory 903 is configured to store program instructions; and the processor 902 is configured to invoke the program instructions stored in the memory 903 to perform the steps executed by the source RAN in the embodiments corresponding to FIGS. 5-7.

In the embodiments of the present application, the methods provided by the embodiments of the present application may be implemented by executing computer programs (including program codes) capable of performing the steps related to the above methods on a general purpose computing device such as a computer that includes processing elements and storage elements, such as a CPU, Random Access Memory (RAM), Read-Only Memory (ROM), etc. The computer programs may be recorded on, for example, a computer-readable recording medium, loaded into the above computing device through the computer-readable recording medium, and executed therein.

Based on the same inventive concept, the principle for solving problems and beneficial effects of the communication apparatus 90 provided in the embodiments of the present application are similar to those of the methods in the embodiments shown in FIGS. 5-7 of the present application. Reference may be made to the principles and beneficial effects of the method implementation. For brevity, details are not repeated herein.

The above communication apparatus may be, for example, a chip or a chip module.

An embodiment of the present application also provides a chip. In an implementation, the chip is configured to: transmit a first query request message, the first query request message comprising identification information of M candidate cells, the first query request message requesting a query for information on time service of the M candidate cells, M being an integer greater than or equal to 1; and receive a first query response message, the first query response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the chip is further configured to: determine a target cell according to the information on time service of the N candidate cells, parameters of time service of the target cell meeting the requirements for time service.

Alternatively, the chip is further configured to: receive a first message, the first message comprising identification information of the M candidate cells.

Alternatively, the chip is further configured to: transmit a second message, the second message comprising identification information of the target cell.

Alternatively, the chip is further configured to: receive a second query request message, the second query request message comprising identification information of K candidate cells, the second query request message requesting a query for information on time service of the K candidate cells, K being an integer greater than or equal to 1.

Alternatively, the chip is further configured to: transmit a second query response message, the second query response message comprising the information on time service of H candidate cells, H being an integer greater than or equal to 1 and less than or equal to N.

Alternatively, the second query request message further comprises identification information of a criterion for time service, the criterion for time service indicating requirements for time service.

Alternatively, the chip is further configured to: determine the results of time service of the N candidate cells according to the parameters of time service of the N candidate cells and the requirements for time service.

Alternatively, the chip is further configured to: receive a third message, the third message comprising identification information of the target cell, parameters of time service of the target cell meeting the requirements for time service.

Alternatively, the third message further comprises group identification information of the target cell.

In another implementation, the chip is configured to: receive a query request message, the query request message comprising identification information of M candidate cells, the query request message requesting a query for information on time service of the M candidate cells, M being an integer greater than or equal to 1; and transmit a query response message, the query response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the information on time service of the N candidate cells comprises parameters of time service of the N candidate cells.

Alternatively, the parameters of time service comprise any one or more parameters of: quality of service, area of service, and time of service.

In yet another implementation, the chip is configured to: transmit a first request message, the first request message comprising identification information of M candidate cells, the first request message requesting a query for information on time service of the M candidate cells, M being an integer greater than or equal to 1; and receive a first response message, the first response message comprising the information on time service of N candidate cells, N being an integer greater than or equal to 1 and less than or equal to M.

Alternatively, the information on time service of the N candidate cells comprises results of time service of the N candidate cells, a result of time service of an n-th candidate cell indicating whether or not parameters of time service of the n-th candidate cell meet requirements for time service, n being an integer greater than or equal to 1 and less than or equal to N.

Alternatively, the chip is further configured to: determine a target cell according to the information on time service of the N candidate cells, parameters of time service of the target cell meeting the requirements for time service.

Alternatively, the first request message further comprises identification information of a criterion for time service, the criterion for time service indicating requirements for time service.

Alternatively, the chip is further configured to: transmit a handover request message, the handover request message comprising identification information corresponding to the target cell.

Alternatively, the handover request message further comprises group identification information of the target cell.

Referring to FIG. 10, FIG. 10 is a schematic structure diagram of a chip module provided by an embodiment of the present application. The chip module 100 may perform the related steps by the communication apparatus 80 in the method embodiments mentioned above, and the chip module 100 includes: a communication interface 1001 and a chip 1002.

The communication interface is configured for internal communication within the chip module, or for communication between the chip module and external devices. The chip is configured to implement the functionality of the communication apparatus in the embodiments of the present application, particularly referring to the embodiments corresponding to FIGS. 5-7. Alternatively, the chip module 100 may further include a storage module 1003 and a power module 1004. The storage module 1003 is configured to store data and instructions. The power module 1004 is configured to provide power for the chip module.

For apparatuses or products applied to or integrated into a chip module, each module included may be implemented in hardware such as circuits, and different modules may be located in the same component (e.g., chip, circuit module, etc.) or different components of the chip module, or at least some modules may be implemented by software programs executing on a processor integrated into the chip module, and the remaining (if any) modules may be implemented in hardware such as circuits.

An embodiment of the present application also provides a computer-readable storage medium having computer-readable instructions stored therein, the computer-readable instructions, when being executed, implementing the methods provided by the above method embodiments.

An embodiment of the present application also provides a computer program or computer program product including code or instructions, the code or instructions, when being executed on a computer, causing the computer to perform the methods provided by the above method embodiments.

Regarding the various modules/units included in various apparatuses and products described in the above embodiments, they may be software modules/units, hardware modules/units, or partly software modules/units and partly hardware modules/units. For example, for apparatuses or products applied to or integrated into a chip, each module/unit included may be implemented in hardware such as circuits, or at least some modules/units may be implemented in software programs executing on a processor integrated into the chip, and the remaining (if any) modules/units may be implemented in hardware such as circuits; for apparatuses or products applied to or integrated into a chip module, each module/unit included may be implemented in hardware such as circuits, and different modules/units may be located in the same component (e.g., chip, circuit module, etc.) or different components of the chip module, or at least some modules/units may be implemented in software programs executing on a processor integrated into a chip module, and the remaining (if any) modules/units may be implemented in hardware such as circuits; for apparatuses or products applied to or integrated into a terminal, each module/unit included may be implemented in hardware such as circuits, different modules/units may be located in the same component (e.g., chip, circuit module, etc.) or different components of the terminal, or at least some modules/units may be implemented by software programs executing on a processor integrated into the terminal, and the remaining (if any) modules/units may be implemented in hardware such as circuits.

It should be noted that for the method embodiments mentioned above, they are described as a series of combination of actions for a brevity of description. However, those skilled in the art should appreciate that the present application is not limited by the described sequence of actions, as some steps may be performed in other sequences or simultaneously according to the present application. Secondly, those skilled in the art should also appreciate that the embodiments described in the specification are all preferred embodiments, and not all the actions and modules involved are required by the present application.

The steps in the method embodiments of the present application may be adjusted in sequence, merged, and deleted according to practical needs.

The modules in the apparatus embodiments of the present application may be merged, divided, and deleted according to practical needs.

Those of ordinary skill in the art should appreciate that all or some of the steps in the various methods of the above embodiments may be completed by instructing related hardware through a program. The program may be stored in a computer-readable storage medium. The readable storage medium may include: flash drive, ROM, RAM, magnetic disk, or optical disk, etc.

The above disclosure is only a preferred embodiment of the present application and merely a part of the embodiments of the present application, which cannot be used to limit the scope of the present application.

1. A method for cell selection, comprising:
transmitting a first query request message, the first query request message comprising identification information of M candidate cells, the first query request message requesting a query for information on time service of the M candidate cells, M being an integer greater than or equal to 1; and
receiving a first query response message, the first query response message comprising the information on time service of N candidate cells, N being an integer greater than or equal to 1, and less than or equal to M.

2. The method according to claim 1, wherein
the information on time service of the N candidate cells comprises results of time service of the N candidate cells, a result of time service of an n-th candidate cell indicating whether or not parameters of time service of the n-th candidate cell meet requirements for time service;
n being an integer greater than or equal to 1, and less than or equal to N.

3. The method according to claim 1, further comprising:
determining a target cell according to the information on time service of the N candidate cells, parameters of time service of the target cell meeting the requirements for time service.

4. The method according to claim 1, wherein before the transmitting the first query request message, the method further comprises:
receiving a first message, the first message comprising the identification information of the M candidate cells.

5. The method according to claim 1, further comprising:
transmitting a second message, the second message comprising identification information of the target cell.

6. The method according to claim 1, wherein before the transmitting the first query request message, the method further comprises:
receiving a second query request message, the second query request message comprising identification information of K candidate cells, the second query request message requesting a query for information on time service of the K candidate cells, K being an integer greater than or equal to 1.

7. The method according to claim 6, wherein after the receiving the first query response message, the method further comprises:
transmitting a second query response message, the second query response message comprising the information on time service of H candidate cells, H being an integer greater than or equal to 1, and less than or equal to N.

8. The method according to claim 6, wherein the second query request message further comprises identification information of a criterion for time service, the criterion for time service indicating requirements for time service.

9. The method according to claim 8, further comprising:
determining the results of time service of the N candidate cells according to the parameters of time service of the N candidate cells and the requirements for time service.

10. The method according to claim 6, further comprising:
receiving a third message, the third message comprising identification information of a target cell, parameters of time service of the target cell meeting the requirements for time service.

11. The method according to claim 10, wherein the third message further comprises group identification information of the target cell.

12. A method for cell selection, comprising:
receiving a query request message, the query request message comprising identification information of M candidate cells, the query request message requesting a query for information on time service of the M candidate cells, M being an integer greater than or equal to 1; and
transmitting a query response message, the query response message comprising the information on time service of N candidate cells, N being an integer greater than or equal to 1, and less than or equal to M.

13. The method according to claim 12, wherein
the information on time service of the N candidate cells comprises results of time service of the N candidate cells, a result of time service of an n-th candidate cell indicating whether parameters of time service of the n-th candidate cell meet requirements for time service, n being an integer greater than or equal to 1, and less than or equal to N.

14. The method according to claim 12, wherein the information on time service of the N candidate cells comprises parameters of time service of the N candidate cells.

15. The method according to claim 14, wherein the parameters of time service comprise any one or more parameters of: quality of service, area of service, and time of service.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A communication apparatus, comprising:
a memory, and
a processor communicatively coupled to the memory, the processor configured to:
transmit a first query request message, the first query request message comprising identification information of M candidate cells, the first query request message requesting a query for information on time service of the M candidate cells, M being an integer greater than or equal to 1; and
receive a first query response message, the first query response message comprising the information on time service of N candidate cells, N being an integer greater than or equal to 1, and less than or equal to M.

31. The communication apparatus according to claim 30, wherein the processor further configured to:
determine a target cell according to the information on time service of the N candidate cells, parameters of time service of the target cell meeting the requirements for time service.

32. The communication apparatus according to claim 30, wherein the processor, before transmit the first query request message, being further configured to:
receive a first message, the first message comprising the identification information of the M candidate cells.

33. The communication apparatus according to claim 30, wherein the processor further configured to:
transmit a second message, the second message comprising identification information of the target cell.

34. The communication apparatus according to claim 30, wherein the processor, before transmit the first query request message, being further configured to:
receive a second query request message, the second query request message comprising identification information of K candidate cells, the second query request message requesting a query for information on time service of the K candidate cells, K being an integer greater than or equal to 1.
